(19) United States
(12) Patent Application Publication
(10) Pub. No.: US 2007/0106560 A1
(43) Pub. Date: May 10, 2007

(54) ELECTRONIC, COMPUTER-IMPLEMENTED METHOD AND SYSTEM OF TRACKING PURCHASE ORDER HISTORY

(75) Inventor: Jay Shields, Canton, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD MOTOR COMPANY, Dearborn, MI (US)

(21) Appl. No.: 11/164,112

(22) Filed: Nov. 10, 2005

(51) Int. Cl. G06Q 30/00

(52) U.S. Cl. 705/26

(57) ABSTRACT

A computer-implemented method for tracking purchase orders in a distributed enterprise. The method can include electronically receiving and storing at least a first and second version of a purchase order. Each version has a date and number and the second version is a purchase order amendment or revision to the first version of the purchase order. The method also can include electronically receiving input from a user through a purchase order tracking tool. The user input identifies the first or second version by date, revision or amendment. The method also includes electronically retrieving the first or second version based on the user input.

### BACKGROUND OF THE INVENTION

1. Field of the Invention

One aspect of the present invention generally relates to an electronic method and system of tracking purchase order history.

2. Background Art

International distributed enterprises, for example manufacturing enterprises, globally requisition suppliers for a tremendous amount of indirect and direct materials in the operation of their business. Indirect and direct materials can refer goods and/or services. Direct materials refer to those that are needed for the product, whereas indirect materials support production of the product. For example, in the automotive industry, direct materials can be fenders, engine parts, transmission parts, manufacturing labor, etc. On the other hand, indirect materials can be pencils, paper, building heating and cooling, administrative labor, etc.

Due to the multitude of global transactions relating to material purchases, distributed enterprises have used the power of computers to implement systems that have functionality to handle purchasing, i.e. to generate purchase orders, and to receive goods and services, and accounts payable, i.e. to generate invoices on behalf of suppliers, and to pay suppliers. These computer systems also offer functionality to generate, amend, and revise purchase orders. For example, the Oracle 11i procurement computer system, available from Oracle Corporation, 500 Oracle Parkway, Redwood Shores, Calif. 94065, has functionality to administrate purchase orders. However, the purchase order tracking functionality is unfit for many objectives of international distributed enterprises.

For example, this functionality is not robust enough to track purchase order history to detailed level necessary for tax auditing purposes. Moreover, the functionality does not adequately produce detailed information, for instance, terms and conditions, regarding purchase orders as they change over time for reporting and printing purposes. Further, certain amendments to purchase orders may not be reflected in the procurement system. As a further disadvantage, purchase order changes are sporadically reported to the supplier base for international distributed enterprises. For example, suppliers may receive notifications for only a portion of applied changes, leaving them unaware of other amendments that may need to be adjusted by the supplier.

In light of the foregoing, what is needed is a robust electronic method and system of purchase order tracking. Moreover, an electronic method and system is needed to give users, for example, buyers and suppliers, the ability to view, compare, and print purchase orders for any amendment/revision or date. Further, an electronic method and system of purchase order tracking is needed to allow users the ability to view purchase orders in an independent state, as the purchase order existed on a certain date.

### SUMMARY OF THE INVENTION

One aspect of the present invention is a robust electronic method and system of purchase order tracking. Another aspect of the present invention is an electronic method and system of purchase order tracking including the ability to view, compare, and print purchase orders for any amendment, revision or date. Yet another aspect of the present invention is an electronic method and system of purchase order tracking that allows users the ability to view purchase orders in an independent state, as the order existed on a certain date.

According to a first embodiment of the present invention, a computer-implemented method for tracking purchase orders in a distributed enterprise is disclosed. The method includes electronically receiving and storing at least a first and second version of a purchase order. Each version of the purchase order has a date and version number. The second version is a purchase order amendment or revision to the first version of the purchase order. The method also includes electronically receiving input from a user through a purchase order tracking tool. The user input identifies the first or second version by date, revision or amendment. The method also includes electronically retrieving the first or second version based on the user input.

According to a second embodiment of the present invention, a computer-implemented system for tracking purchase orders in a distributed enterprise is disclosed. The system can include one or more computers. The one or more computers can be configured to electronically receive and store at least a first and second version of a purchase order. Each version of the purchase order has a date and version number and the second version is a purchase order amendment or revision to the first version of the purchase order. The one or more computers can be further configured to electronically receive input from a user through a purchase order tracking tool. The input identifies the first or second version of the purchase order by date, revision or amendment. The one or more computers are further configured to electronically retrieve the first or second version of the purchase order based on the user input.

According to a third embodiment of the present invention, a computer-implemented apparatus for tracking purchase orders in a distributed enterprise. The apparatus includes a means for electronically receiving and storing at least a first and second version of a purchase order. Each version has a date or version number and the second version is a purchase order amendment or a revision to the first version of the purchase order. The apparatus also includes a means for electronically receiving input from a user through a purchase order tracking tool where the user input identifies the first or second version by date, number or amendment. The apparatus also includes a means for electronically retrieving the first or second version of the purchase order based on the user input.

The above and other objects, features, and advantages of the present invention are readily apparent from the following detailed description of the best mode for carrying out the invention when taken in connection with the accompanying drawings.

### BRIEF DESCRIPTION OF THE DRAWINGS

The features of the present invention which are believed to be novel are set forth with particularity in the appended claims. The present invention, both as to its organization and manner of operation, together with further objects and advantages thereof, may best be understood with reference to the following description, taken in connection with the accompanying drawing which:

FIG. 1 is a block diagram illustrating an overall system for implementing one or more embodiments of the present invention;

FIG. 2 is an example of an electronic purchase order form that can be utilized with one or more embodiments of the present invention;

FIG. 3 is a graphical user interface (GUI) for viewing purchase documents based on date or revision number;

FIG. 4 is a GUI for displaying captured and archived changes made to a purchase order including an attachment; and

FIG. 5 is a GUI for searching, locating and viewing a purchase order version by entering a purchase order revision number or date.

### DETAILED DESCRIPTION OF EMBODIMENTS

As required, detailed embodiments of the present invention are disclosed herein. However, it is to be understood that the disclosed embodiments are merely exemplary of the invention that may be embodied in various and alternative forms. Therefore, specific functional details described herein are not to be interpreted as limiting, but merely as a representative basis for the claims and/or as a representative basis for teaching one of ordinary skill in the art to variously employ the present invention.

In certain embodiments of the present invention, a computer-implemented purchase order tracking tool is disclosed that enables users, for example, buyers, approvers, requisitioners, and suppliers to efficiently view and print purchasing documents, for example, purchase orders, including header and line details in an organized format, for example, identification of all changes made from a previous amendment of the purchasing document.

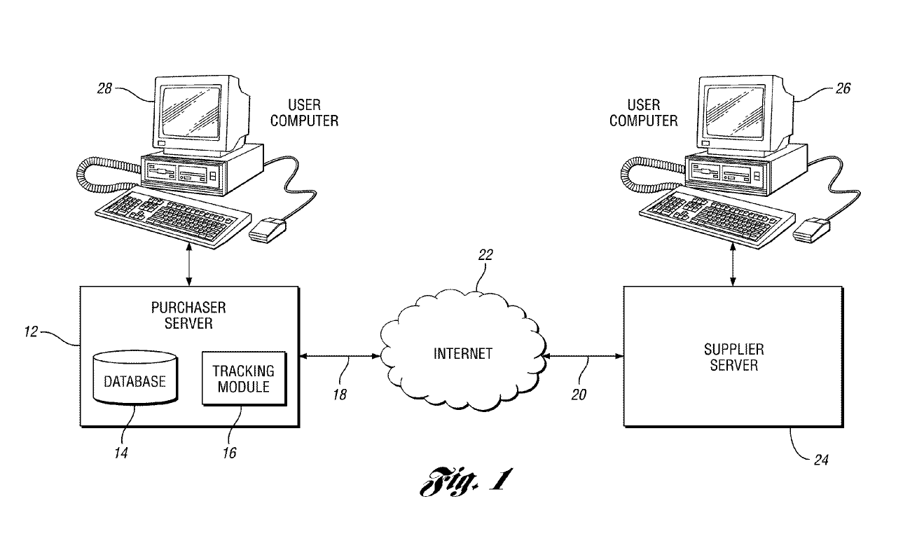

FIG. 1 is a block diagram illustrating overall system 10 for implementing one embodiment of the present invention. Overall system 10 includes purchaser server 12, which includes database 14 and tracking module 16. Database 14 may include information relating to purchase orders of a distributed enterprise. Tracking module 16 may include functionality to track the history of purchase order changes and amendments. Purchaser server 12 can also include a procurement module (not shown) having purchasing and accounts payable functionality. Purchaser server 12 transmits and receives data from purchaser user computer 28, which can format and display data pertaining to the purchase order tracking process.

Purchaser server 12 is also connected, via communication lines 18 and 20, through the Internet 22, to supplier server 24. Supplier server 24 transmits and receives data from supplier user computer 26, which can format and display data pertaining to the purchase order tracking process.

Servers 12 and 24, and user computers 26 and 28 can be interconnected to a network, for example, a local area network (LAN) or a wide area network (WAN), through a variety of interfaces, including, but not limited to dial-in connections, cable modems, high-speed lines, and hybrids thereof. Firewalls can be connected in any communication path to protect certain parts of the network from hostile and unauthorized use.

According to the embodiment depicted in FIG. 1, servers 12 and 24, and user computers 22 and 24 support TCP/IP protocol which has input and access capabilities via two-way communication lines.

The communication lines included in computer system 10 can be an intranet-adaptable communication line, for example, a dedicated line, a satellite link, an Ethernet link, a public telephone network, a private telephone network, and hybrids thereof. The communication lines can also be intranet-adaptable. Examples of suitable communication lines include, but are not limited to, public telephone networks, public cable networks, and hybrids thereof.

Tracking module 16 can have computer-readable instructions executable to provide abilities and features to the users of computer system 10. These abilities and features may be implemented through a purchase order tracking tool interface between the users and tracking module 16. Non-limiting examples of users include requisitioners, purchasers, buyers and suppliers working in a distributed enterprise environment.

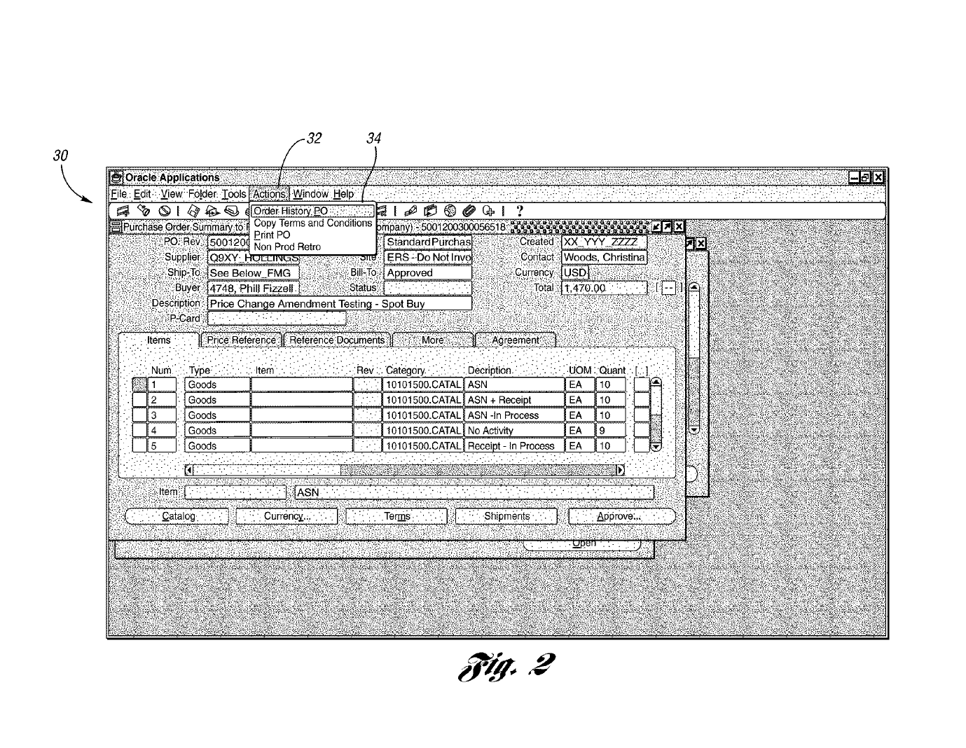

Aspects of this invention contemplate the tracking of the history of purchase orders. FIG. 2 is an example of GUI 30 that can be utilized along with embodiments of the present invention. GUI 30 primarily functions as an electronic purchase order, and is a portion of the Oracle 11i procurement computer system. This system can be modified so that the user can select the “Actions” pull down menu 32, and then the “Order History PO” list item 34 to access portions of the purchase order tracking tool interface.

The purchase order tracking tool interface can provide the ability for users to view, compare, and/or print order details, including identification of changes made from the previous amendment or revision. In certain embodiments, “amendment” can refer to a revision generated in a computer-implemented procurement system. For data captured in a history archive or database of the procurement system, an amendment or revision number can be generated for each specific change.

Another aspect of the present invention includes the ability to view, compare (e.g. changes made from a previously approved order version), and print a specific order amendment as when it was revised and approved.

Another aspect of the present invention includes the ability to view and print an original order version as when it was first generated and approved.

Another aspect of the present invention includes the ability to view and print a merged order document. In certain embodiments, merged order document refers to the appearance of an order in its last approved revised state plus all approved line level amendments in one version. The user has the ability to access one document summarizing all line details, including, but not limited to, those lines that are cancelled, closed, or any other action taken on the order that results in a line disappearing from a viewable state. In certain embodiments, for lines that are authorized via a purchase order summary control feature, a date can be displayed indicating when the action took place.

Another aspect of the present invention includes the ability to view, compare, and print an order document regardless of its header status, for example, approved, canceled, approved and closed.

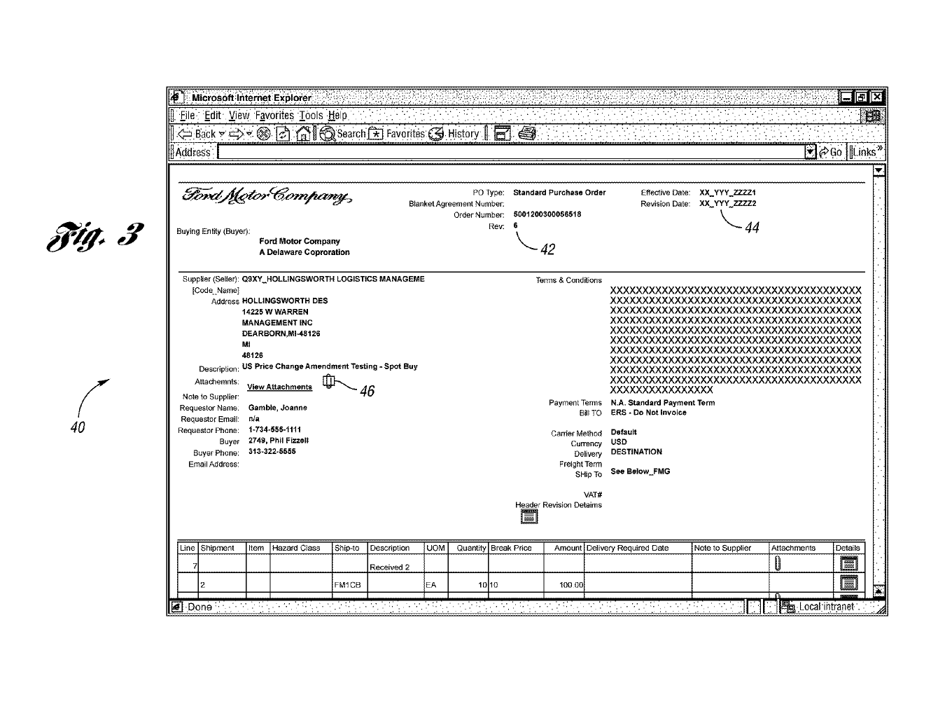

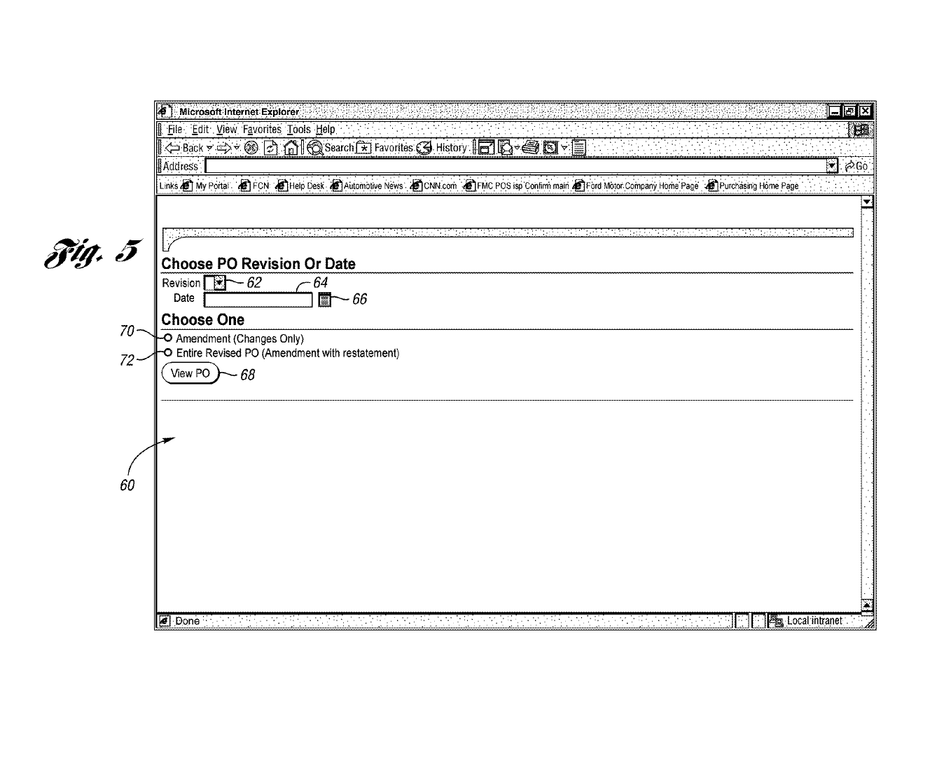

The purchase order tracking tool interface can provide the ability to view purchasing documents based on previous and current revisions. FIG. 3 is a graphical user interface (GUI) for viewing purchasing documents based on revision or amendment. GUI 40 can be hosted by server 12 and/or 24 and displayed on user computer 22 and/or 24, respectively. The user is prompted to enter a revision number 42 or a date 44, for example, on a separate pop-up window (not shown). Upon pressing the “View PO” (FIG. 5) button on the pop-up window, the relevant version of the purchase order document can be displayed on GUI 40.

The purchase order tracking tool interface can provide the ability to print purchasing documents based on previous and current revisions. In certain embodiments, user can select “File” pull down menu 46 and print list item (not shown) to print purchase orders reflected by previous and current revisions, as depicted in FIG. 3.

The purchase order tracking tool interface can provide the ability to compare purchasing documents between revisions.

The purchase order tracking tool interface can provide the ability to view merged documents, including, but not limited to, current open lines on a purchase order, and/or previously cancelled or closed lines. For example, order lines or shipments which were closed or canceled in any future or current revision, can be picked up as active lines in the past dated revision.

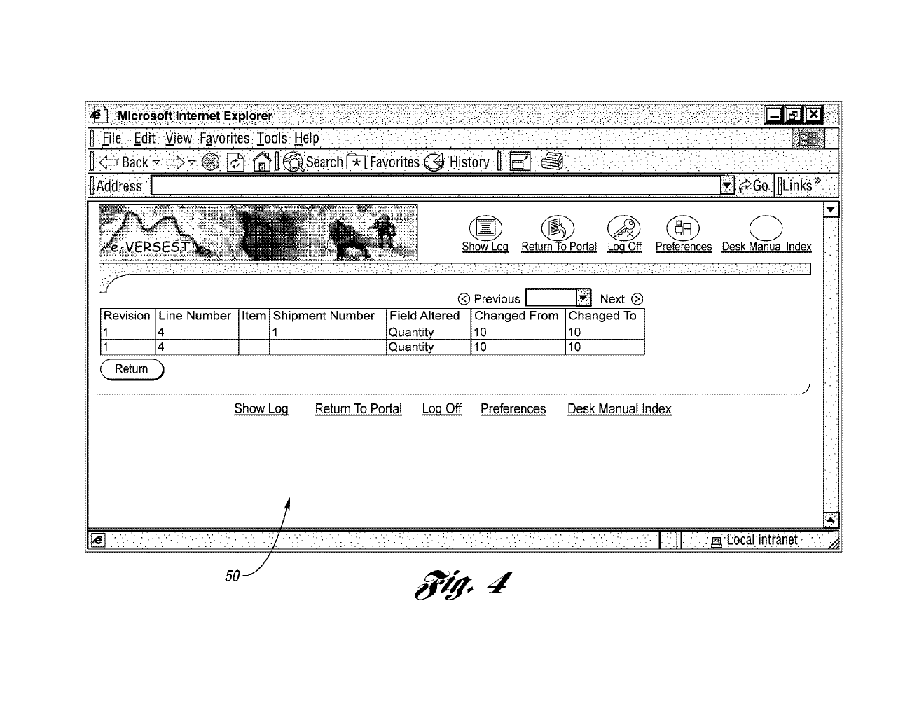

The purchase order tracking tool interface can provide the ability to view contents of attachments from previous versions of purchasing documents. FIG. 4 is a GUI 50 so for displaying captured and archived attachments.

The purchase order tracking tool interface can provide the ability to show contents of added, deleted or adjusted attachments. The purchase order tracking tool can capture and/or archive attachment changes (additions, deletions or adjustments) within each revision over time throughout the history of the order.

The purchase order tracking tool interface can provide the ability to increase the revision number of a document when modifying an attachment.

The purchase order tracking tool interface can provide the ability to increase revision numbers of documents when adding, deleting or adjusting an attachment.

The purchase order tracking tool interface can provide the ability to increase revisions of documents when changing any field changeable on a purchase order summary for headers or lines.

The purchase order tracking tool interface can provide the ability to view document revisions by revision number or date. In addition the user can simultaneously determine whether to view a version of an order containing only changes or a picture of the entire order as it appears after the changes were applied and approved to the purchase order. FIG. 5 is a GUI 60 for entering a purchase order revision number 62 or a date 64. Entry of the date can be aided by selecting calendar icon 66, which displays a calendar for user reference. The user can view the purchase order retrieved by amendment (by selecting radio button 70) or the entire revised purchase order by selecting radio button 72). Once the appropriate data is entered and view PO button 68 is clicked, the appropriate purchase order history is retrieved and displayed (for example, as depicted in FIG. 3). In certain embodiments, it is mandatory to specify at least one parameter in GUI 60. If the date is provided, the purchase order history tool can automatically determine an active revision of a document at the provided input date. In certain embodiments, the date refers to the date the purchase order was approved, and not when it was revised. This may be relevant if the purchase order is revised on the date and approved on a later date.

The purchase order tracking tool interface can provide the ability to view the original version (revision #0), the latest approved version (revision #x) or any revisions and/or amendments made in between (revision # greater than 0 and less than x). The selecting and viewing of revisions by number can be facilitated through the use of a number of click buttons.

The purchase order tracking tool interface can provide the ability to automatically print attachments. The purchase order tracking tool interface includes the functionality to capture and archive attachment changes made to a purchase order. The user can query, view and print any version of the order, including the attachments as they appear for each revision of the order. The user can click on an attachment icon to display a list of the attachments to a purchase order. The user can select an attachment to display it. Once displayed, the user can print the attachment if desired. GUI 40 of FIG. 3 includes icon 46 of a paperclip with a piece of paper. This icon 46 signifies that there is an attachment for this version of the purchase order. By clicking on the paperclip icon 46, a list of attachments is displayed in a separate window or the same window. The user can select an icon associated with one of the attachments to display it and then print it if desired.

The purchase order tracking tool can include a snapshot form of a purchase order and amendments applied over the life of the purchase order.

The purchase order tracking tool can track changes made to a purchase order even if the change did not originally generate amendments or was not captured in history using an existing procurement software application, for example attachments (e.g. soft copy documents, web site URLs, product free form text notes) and control actions, e.g. closing or canceling an order or order line. Furthermore, purchase order changes applied within a certain build can trigger the creation and submittal of a notification to suppliers.

Another aspect of the present invention includes the ability to generate, identify, and capture amendments in history for the following adjustments, in no particular order:

(1) Any change to attachments seen by suppliers at a header or line level. In certain amendments, this capability applies only to attachments that are displayed to suppliers, for example, those with a category of “To Supplier” or “Miscellaneous.” Otherwise, the attachments are captured internally for viewing and do not require an amendment generation.

(2) Control changes from purchase order (PO) summary, for example, cancel PO, close PO, cancel PO line, close PO line, and re-open actions at the header and line level.

(3) Non-production order header amendment effective date.

In certain embodiments, the users can access the functionality of certain aspects of the present invention from a purchase order form. In other words, the buyer or supplier can call up a purchasing document before querying for a specific amendment version. Non-limiting examples of queries include PO summary, purchase orders form, and the PO tab in the Supplier Portal.

Once the buyer is at the desired order document version, users have the ability to view and print the order details by entering and/or querying one or more of the following criteria:

(a) revision number or (b) date.

The user has the ability to select a click button from a form, for example, a GUI, which allows the user to efficiently display the latest approved version. In certain embodiments, it is not a requirement to run a query.

The user has the ability to select from a list of documents in a form that allows the user to print attachments specific to any version of the order.

When viewing the order only, the user has the ability to identify what elements have changed from the previously generated revision approved by the purchasing department.

The approved amendments can be displayed based on a given date or for a particular amendment version, including attachments, clauses, comments, and/or other fields on the purchase order.

An amendment can be generated when the non-production blanket purchase agreement effective dates (start and expiration dates) are adjusted.

The before mentioned aspects can be applied to all order types, for example, production and non-production. Non-limiting examples of standard non-production orders include release orders and spot buy standard purchase orders and non-limiting examples of standard production orders may include tool orders and lump sum orders. Non-limiting examples of blanket non-production orders include BPAs, catalog, converted or manually created by the buyer and non-limiting examples of blanket production purchase orders.

While the best mode for carrying out the invention has been described in detail, those familiar with the art to which this invention relates will recognize various alternative designs and embodiments for practicing the invention as defined by the following claims.

What is claimed is:

1. A computer-implemented method for tracking purchase orders in a distributed enterprise, the method comprising:
electronically receiving and storing at least a first and second version of a purchase order, each version having a date and number, the second version being a purchase order amendment or revision to the first version;
electronically receiving input from a user through a purchase order tracking tool, the user input identifying the first or second version by date, revision or amendment; and
electronically retrieving the first or second version based on the user input.

2. The method of claim 1 further comprising electronically formatting the first or second version as an independent, stand-alone document.

3. The method of claim 1 wherein the purchase order tracking tool including functionality to display the first and second versions simultaneously so as to allow the user to compare the first and second versions.

4. The method of claim 1 wherein the purchase order tracking tool includes functionality to display or print an attachment to the first or second version.

5. The method of claim 1 wherein the purchase order tracking tool includes functionality to display or print an altered attachment to the first or second version.

6. The method of claim 1 wherein the number of the first version is a first revision number, the number of the second version is a second revision number, and the purchase order tracking tool includes functionality to increase the first revision number to the second revision number based on a change to an attachment of the first version.

7. The method of claim 1 wherein the purchase order tracking tool includes functionality to receive, store, and retrieve specific versions of a purchase order.

8. A computer-implemented system for tracking purchase orders in a distributed enterprise, the system including one or more computers, the one or more computers configured to:
electronically receive and store at least a first and second version of a purchase order, each version having a date and number, the second version being a purchase order amendment or revision to the first version;
electronically receive input from a user through a purchase order tracking tool, the input identifying the first or second version by date, revision or amendment; and
electronically retrieve the first or second version based on the user input.

9. The system of claim 8 wherein the one or more computers are further configured to electronically format the first or second version as an independent, stand-alone document.

10. The system of claim 8 wherein the purchase order tracking tool including functionality to display the first and second version simultaneously so as to allow the user to compare the first and second versions.

11. The system of claim 8 wherein the purchase order tracking tool includes functionality to display or print an attachment to the first or second version.

12. The system of claim 8 wherein the purchase order tracking tool includes functionality to display or print an altered attachment to the first or second version.

13. The system of claim 8 wherein the number of the first version is a first revision number, the number of the second version is a second revision number, and the purchase order tracking tool includes functionality to increase the first revision number to the second revision number based on a change to an attachment of the first version.

14. The system of claim 8 wherein the purchase order tracking tool includes functionality to receive, store, and retrieve specific versions of a purchase order.

15. A computer-implemented apparatus for tracking purchase orders in a distributed enterprise, the apparatus comprising:
means for electronically receiving and storing at least a first and second version of a purchase order, each version having a date and number, the second version being a purchase order amendment or revision to the first version;
means for electronically receiving input from a user through a purchase order tracking tool, the user input identifying the first or second version by date, number or amendment; and
means for electronically retrieving the first or second version based on the user input.

16. The apparatus of claim 15 further comprising means for electronically formatting the first or second version as an independent, stand-alone document.

17. The apparatus of claim 15 wherein the purchase order tracking tool including functionality to display the first and second versions simultaneously so as to allow the user to compare the first and second versions.

18. The apparatus of claim 15 wherein the purchase order tracking tool includes functionality to display or print an attachment to the first or second version.

19. The apparatus of claim 15 wherein the purchase order tracking tool includes functionality to display or print an altered attachment to the first or second version.

20. The apparatus of claim 15 wherein the number of the first version is a first revision number, the number of the second version is a second revision number, and the purchase order tracking tool includes functionality to increase the first revision number to the second revision number based on a change to an attachment of the first version.
